(19) United States
(12) Patent Application Publication
(10) Pub. No.: US 2024/0354668 A1
(43) Pub. Date: Oct. 24, 2024

(54) SYSTEMS, APPARATUSES, METHODS, AND COMPUTER PROGRAM PRODUCTS FOR PERFORMING ONE OR MORE IMPROVED OPERATIONS ACTIONS

(71) Applicant: HONEYWELL INTERNATIONAL INC., Charlotte, NC (US)

(72) Inventors: Shubhanjali K, Bangalore (IN); Kushal RAMESH, Bangalore (IN); Sharmila MUTHUKRISHNAN, Bangalore (IN); Sagar DATTA, Bangalore (IN)

(21) Appl. No.: 18/305,058

(22) Filed: Apr. 21, 2023

(51) Int. Cl. G06Q 10/0631; G06Q 20/08

(52) U.S. Cl. CPC G06Q 10/0631; G06Q 20/085

(57) ABSTRACT

Systems, apparatuses, computer program products, and methods are provided herein. For example, a computer-implemented method may include receiving registration data associated with a plurality of sensors. In some embodiments, the computer-implemented method may include receiving operations data representing operations of a plurality of assets. In some embodiments, the computer-implemented method may include applying the operations data to an improvement model to generated improved operations data based at least in part on the registration data and the operations data based at least in part on the registration data and the operations data. In some embodiments, the improved operations data may include a plurality of improved operations data sets. In some embodiments, the computer-implemented method may include initiating performance of one or more improved operations actions based at least in part of the improved operations data.

### TECHNOLOGICAL FIELD

Embodiments of the present disclosure relate generally to performing one or more improved operations actions.

### BACKGROUND

Applicant has identified many technical challenges and difficulties associated with performing one or more improved operations actions. Through applied effort, ingenuity, and innovation, Applicant has solved problems related to performing one or more improved operations actions by developing solutions embodied in the present disclosure, which are described in detail below.

### BRIEF SUMMARY

Various embodiments described herein relate to systems, apparatuses, methods, and computer program products for performing one or more improved operations actions.

In accordance with one aspect of the disclosure, a computer-implemented method is provided. In some embodiments, the computer-implemented method may include receiving registration data associated with a plurality of sensors. In some embodiments, the computer-implemented method may include receiving operations data representing operations of a plurality of assets. In some embodiments, the operations data is captured by the plurality of sensors. In some embodiments, the computer-implemented method may include applying the operations data to an improvement model to generate improved operations data based at least in part on the registration data and the operations data. In some embodiments, the improved operations data comprises a plurality of improved operations data sets. In some embodiments, each improved operations data set of the plurality of improved operations data sets is associated with one of the plurality of assets. In some embodiments, the computer-implemented method may include initiating performance of one or more improved operations actions based at least in part on the improved operations data.

In some embodiments, applying the operations data to the improvement model to generate improved operations data occurs in real-time.

In some embodiments, applying the one or more improved operations actions may include causing each improved operations data set of the plurality of improved operations data sets to automatically be displayed on an improved operations data set interface of an associated asset of the plurality of assets.

In some embodiments, applying the one or more improved operations actions may include transmitting the improved operations data to a database. In some embodiments, each improved operations data set of the plurality of improved operations data sets is transmitted to a database storage location associated with an associated asset of the plurality of assets.

In some embodiments, receiving operations data representing operations of a plurality of assets is associated with a first bandwidth allocation and transmitting the improved operations data to a database is associated with a second bandwidth allocation.

In some embodiments, the second bandwidth allocation is greater than the first bandwidth allocation.

In some embodiments, applying the one or more improved operations actions may include determining a computing resource consumption for each of the plurality of assets based at least in part on the improved operations data.

In some embodiments, the computer-implemented method may include transmitting a payment request to each of the plurality of assets based at least in part on the computing resource consumption for each of the plurality of assets.

In some embodiments, the plurality of assets comprise at least one building, at least one plant, or at least one vehicle.

In some embodiments, the operations data is associated with a first data size and the improved operations data is associated with a second data size. In some embodiments, the second data size is greater than the first data size.

In accordance with another aspect of the disclosure, an apparatus is provided. In some embodiments, the apparatus may include at least one processor and at least one memory coupled to the at least one processor. In some embodiments, the at least one processor is configured to receive registration data associated with a plurality of sensors. In some embodiments, the at least one processor is configured to receive operations data representing operations of a plurality of assets. In some embodiments, the operations data is captured by the plurality of sensors. In some embodiments, the at least one processor is configured to apply the operations data to an improvement model to generate improved operations data based at least in part on the registration data and the operations data. In some embodiments, the improved operations data comprises a plurality of improved operations data sets. In some embodiments, each improved operations data set of the plurality of improved operations data sets is associated with one of the plurality of assets. In some embodiments, the at least one processor is configured to initiate performance of one or more improved operations actions based at least in part on the improved operations data.

In some embodiments, applying the operations data to the improvement model to generate improved operations data occurs in real-time.

In some embodiments, applying the one or more improved operations actions may include causing each improved operations data set of the plurality of improved operations data sets to automatically be displayed on an improved operations data set interface of an associated asset of the plurality of assets.

In some embodiments, applying the one or more improved operations actions may include transmitting the improved operations data to a database. In some embodiments, each improved operations data set of the plurality of improved operations data sets is transmitted to a database storage location associated with an associated asset of the plurality of assets.

In some embodiments, receiving operations data representing operations of a plurality of assets is associated with a first bandwidth allocation and transmitting the improved operations data to a database is associated with a second bandwidth allocation.

In some embodiments, the second bandwidth allocation is greater than the first bandwidth allocation.

In some embodiments, applying the one or more improved operations actions may include determining a computing resource consumption for each of the plurality of assets based at least in part on the improved operations data.

In some embodiments, the at least one processor is configured to transmit a payment request to each of the plurality of assets based at least in part on the computing resource consumption for each of the plurality of assets.

In some embodiments, the plurality of assets comprise at least one building, at least one plant, or at least one vehicle.

In some embodiments, the operations data is associated with a first data size and the improved operations data is associated with a second data size. In some embodiments, the second data size is greater than the first data size.

In accordance with another aspect of the disclosure, a non-transitory computer-readable storage medium is provided. In some embodiments, the non-transitory computer-readable storage medium may include computer program code for execution by one or more processors of a device. In some embodiments, the computer program code configured to, when executed by the one or more processors, cause the device to receive registration data associated with a plurality of sensors. In some embodiments, the computer program code configured to, when executed by the one or more processors, cause the device to receive operations data representing operations of a plurality of assets. In some embodiments, the operations data is captured by the plurality of sensors. In some embodiments, the computer program code configured to, when executed by the one or more processors, cause the device to apply the operations data to an improvement model to generate improved operations data based at least in part on the registration data and the operations data. In some embodiments, the improved operations data comprises a plurality of improved operations data sets. In some embodiments, each improved operations data set of the plurality of improved operations data sets is associated with one of the plurality of assets. In some embodiments, the computer program code configured to, when executed by the one or more processors, cause the device to initiate performance of one or more improved operations actions based at least in part on the improved operations data.

In some embodiments, applying the operations data to the improvement model to generate improved operations data occurs in real-time.

In some embodiments, applying the one or more improved operations actions may include causing each improved operations data set of the plurality of improved operations data sets to automatically be displayed on an improved operations data set interface of an associated asset of the plurality of assets.

In some embodiments, applying the one or more improved operations actions may include transmitting the improved operations data to a database. In some embodiments, each improved operations data set of the plurality of improved operations data sets is transmitted to a database storage location associated with an associated asset of the plurality of assets.

In some embodiments, receiving operations data representing operations of a plurality of assets is associated with a first bandwidth allocation and transmitting the improved operations data to a database is associated with a second bandwidth allocation.

In some embodiments, the second bandwidth allocation is greater than the first bandwidth allocation.

In some embodiments, applying the one or more improved operations actions may include determining a computing resource consumption for each of the plurality of assets based at least in part on the improved operations data.

In some embodiments, the computer program code configured to, when executed by the one or more processors, transmit a payment request to each of the plurality of assets based at least in part on the computing resource consumption for each of the plurality of assets.

In some embodiments, the plurality of assets comprise at least one building, at least one plant, or at least one vehicle.

In some embodiments, the operations data is associated with a first data size and the improved operations data is associated with a second data size. In some embodiments, the second data size is greater than the first data size.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates exemplary block diagram of an example apparatus that may be specially configured in accordance with an example embodiment of the present disclosure;

FIG. 3 illustrates an exemplary registration data interface in accordance with one or more embodiments of the present disclosure;

FIG. 4 illustrates exemplary improved operations data set interfaces in accordance with one or more embodiments of the present disclosure;

FIG. 5 illustrates one or more databases in accordance with one or more embodiments of the present disclosure;

FIG. 6 illustrates exemplary payment request interfaces in accordance with one or more embodiments of the present disclosure; and

FIG. 7 illustrates a flowchart of an example computer-implemented method in accordance with one or more embodiments of the present disclosure.

### DETAILED DESCRIPTION

Example embodiments will be described more fully hereinafter with reference to the accompanying drawings, in which some, but not all embodiments of disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Example embodiments disclosed herein address technical problems associated with performing one or more improved operations actions. As would be understood by one skilled in the field to which this disclosure pertains, there are numerous example scenarios in which a user may need to perform one or more improved operations actions.

In some examples, a system may be configured to receive operations data representing operations of a plurality of assets. In some examples, the operations data may be captured by a plurality of sensors. In some examples, the system may be configured to perform one or more operations based at least in part on the operations data. However, in some examples, in order for the system to perform the one or more operations it is necessary that the operations data is tagged such that the system may determine which of the plurality of assets and/or which of the plurality of sensors that each portion of the operations data originated from.

An example solution for enabling a system to perform one or more improved operations actions include, for example, having the plurality of sensors transmit, in addition to the operations data, identification data to the system that identifies the asset and/or sensor that the operations data originated from. However, in some examples, the plurality of sensors may not be configured to transmit identification data to the system. In some examples, in order to configure the plurality of sensors to transmit identification data to the system, manual intervention may be required to manually update the firmware associated with the plurality of sensors, which may be costly and time consuming to implement. Additionally, in some examples, having the plurality of sensors transmit operations data and identification data to the system may require substantial bandwidth allocation (e.g., a greater bandwidth allocation than if the plurality of sensors only transmit operations data), which may increase the costs and latency of the system performing one or more operations. As such, there is a need for systems, apparatuses, methods, and computer program products that enable a system to perform one or more operations without the increased costs, latency, bandwidth allocation, and time consumption of having the plurality of sensors transmit operations data and identification data to the system.

Thus, to address these and/or other issues related to performing one or more operations actions, example systems, apparatuses, computer program products, and/or methods are disclosed herein. For example, an embodiment in this disclosure, described in greater detail below, includes a computer-implemented method. In some embodiments, the computer-implemented method may include receiving registration data associated with a plurality of sensors. In some embodiments, the computer-implemented method may include receiving operations data representing operations of a plurality of assets. In some embodiments, the computer-implemented method may include applying the operations data to an improvement model to generate improved operations data based at least in part on the registration data and the operations data. In some embodiments, the improved operations data comprises a plurality of improved operations data sets. In some embodiments, each improved operations data set of the plurality of improved operations data sets is associated with one of the plurality of assets. In some embodiments, the computer-implemented method may include initiating performance of one or more improved operations actions based at least in part on the improved operations data. Accordingly, the systems apparatuses, methods, and computer program products disclosed herein provide for the generation of improved operations data that enables the performance of one or more improved operations actions without the increased costs, latency, bandwidth allocation, and time consumption of having the plurality of sensors transmit operations data and identification data.

### Example Apparatuses and Systems

Embodiments of the present disclosure herein include systems, apparatuses, methods, and computer program products for performing one or more improved operations actions. It should be readily appreciated that the embodiments of the apparatus, systems, methods, and computer program product described herein may be configured in various additional and alternative manners in addition to those expressly described herein.

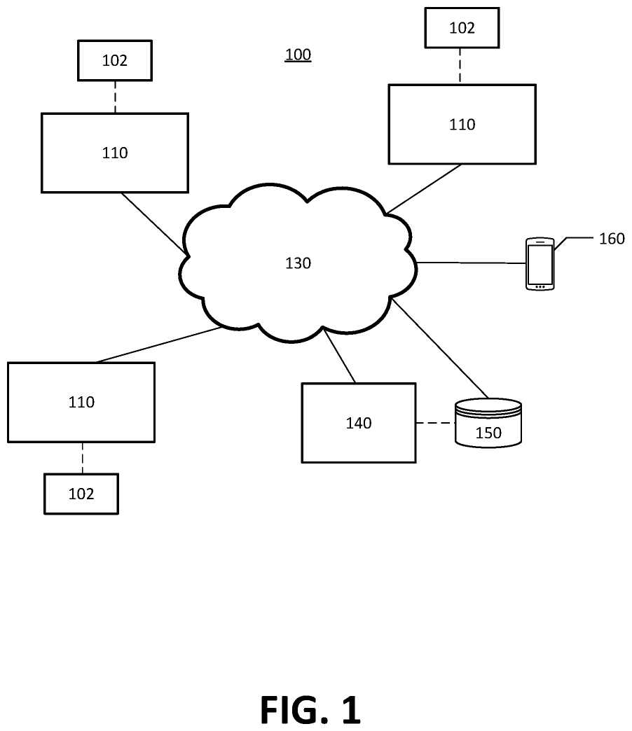

FIG. 1 illustrates an exemplary block diagram of an environment 100 in which embodiments of the present disclosure may operate. Specifically, FIG. 1 illustrates a plurality of sensors 110. In some embodiments, each of the plurality of sensors 110 may be associated with an asset of a plurality of assets 102. In some embodiments, for example, the plurality of assets 102 may be any type of facility associated with a user associated with the environment 100. For example, the plurality of assets 102 may include at least one plant. In this regard, the plurality of assets 102 may, for example, be a processing plant that receives and processes ingredients as inputs to create a final product, such as a hydrocarbon processing plant, a refinery plant, a drilling plant, a fracking plant, and/or the like. Additionally or alternatively, for example, the plurality of assets 102 may include at least one building. In this regard, the plurality of assets 102 may, for example, be an industrial building, office building, warehouse, building associated with a plant, and/or the like. Additionally or alternatively, for example, the plurality of assets 102 may include at least one vehicle. In this regard, the plurality of assets 102 may, for example, be a passenger vehicle, industrial vehicle, warehouse vehicle, and/or the like. In some embodiments, each of the plurality of sensors 110 and/or each of the plurality of assets 102 may be associated with a tenant. In some embodiments a tenant may be an owner and/or operator of an associated sensor and/or asset.

In some embodiments, each sensor of the plurality of sensors 110 may be electronically and/or communicatively coupled to an associated asset of the plurality of assets 102 and/or individual components of an associated asset of the plurality of assets 102. In some embodiments, each sensor of the plurality of sensors 110 may be located remotely, in proximity of, and/or within an associated asset of the plurality of assets 102. In some embodiments, each sensor of the plurality of sensors 110 is configured via hardware, software, firmware, and/or a combination thereof, to perform data intake of one or more types of data associated with one or more of the plurality of assets 102. Additionally or alternatively still, in some embodiments, each sensor of the plurality of sensors 110 is configured via hardware, software, firmware, and/or a combination thereof, to perform data reporting and/or other data output process(es) associated with monitoring or otherwise analyzing operations of one or more of the plurality of assets 102 or specific component(s) thereof. In some embodiments, each sensor of the plurality of sensors 110 may comprises one or more of a gas sensor, a temperature sensor, a humidity sensor, a material composition sensor, a vibration sensor, an acceleration sensor, location sensor, and/or the like.

In some embodiments, each of the plurality of sensors 110 is associated with a determinable location. The determinable location of each of the plurality of sensors 110 in some embodiments represents an absolute position (e.g., GPS coordinates, latitude, and longitude locations, and/or the like) or a relative position (e.g., an identifier representing the of each of the plurality of sensors 110 from a local origin point, such as a local origin point in an associated asset of the plurality of assets 102). Additionally or alternatively, in some embodiments, each of the plurality of assets 102 itself is associated with a determinable location. The determinable location of each of the plurality of assets 102 in some embodiments represents an absolute position (e.g., GPS coordinates, latitude and longitude locations, an address, and/or the like) or a relative position (e.g., an identifier representing the location of each of the plurality of assets 102 as compared to one or more other assets, an enterprise headquarters, or general description in the world for example based at least in part on continent, state, or other definable region).

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include an operations processing system 140. The operations processing system 140 may be electronically and/or communicatively coupled to the plurality of sensors 110, the plurality of assets 102, the one or more user devices 160, and/or the one or more databases 150. The operations processing system 140 may be located remotely, in proximity of, and/or within a particular sensor of the plurality of sensors 110 and/or a particular asset the plurality of assets 102. In some embodiments, the operations processing system 140 is configured via hardware, software, firmware, and/or a combination thereof, to perform data intake of one or more types of data associated with one or more of the plurality of assets 102 and/or one or more of the plurality of sensors 110. Additionally or alternatively, in some embodiments, the operations processing system 140 is configured via hardware, software, firmware, and/or a combination thereof, to generate and/or transmit command(s) that control, adjust, or otherwise impact operations of one or more of the plurality of assets 102, the one or more databases 150, and/or the plurality of sensors 110. Additionally or alternatively still, in some embodiments, the operations processing system 140 is configured via hardware, software, firmware, and/or a combination thereof, to perform data reporting and/or other data output process(es) associated with monitoring or otherwise analyzing operations of one or more of the plurality of assets 102, the one or more databases 150 and/or the plurality of sensors 110, for example for generating and/or outputting report(s) corresponding to the operations performed via the plurality of assets 102 and/or the plurality of sensors 110. For example, in various embodiments, the operations processing system 140 may be configured to execute and/or perform one or more operations and/or functions described herein.

The one or more databases 150 may be configured to receive, store, and/or transmit data. In some embodiments, the one or more databases 150 may be associated with registration data associated with the plurality of sensors 110. Additionally or alternatively, the one or more databases 150 may be associated with operations data representing operations of the plurality of assets 102. Additionally or alternatively, the one or more databases 150 may be associated with improved operations data. In some embodiments, the one or more databases 150 may be associated with operations data and/or registration data received by the operations processing system 140 in real-time. Additionally or alternatively, the one or more databases 150 may be associated with operations data and/or registration data received by the operations processing system 140 on a periodic basis (e.g., the operations data and/or registration data may be received by the operations processing system 140 once per day). Additionally or alternatively, the one or more databases 150 may be associated with operations data and/or registration data received by the operations processing system 140 after the operations processing system 140 has requested the operations data and/or registration data. Additionally or alternatively, the one or more databases 150 may be associated with operations data and/or registration data based on an input (e.g., a user input) into the operations processing system 140 and/or the one or more user devices 160.

The one or more user devices 160 may be associated with users of operations processing system 140. In various embodiments, the operations processing system 140 may generate and/or transmit a message, alert, or indication to a user via one or more user devices 160. Additionally, or alternatively, the one or more user devices 160 may be utilized by a user to remotely access an operations processing system 140. This may be by, for example, an application operating on the one or more user devices 160. A user may access the operations processing system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the operations processing system 140 may include one or more databases 150, which may collectively be located in or at the plurality of assets 102 and/or the plurality of sensors 110.

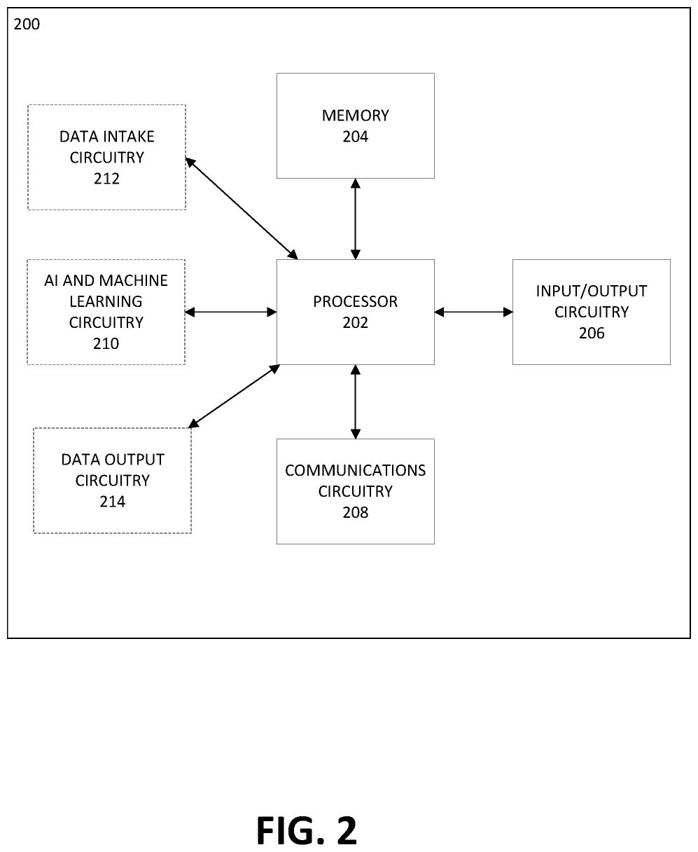

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud based computing apparatus, and/or the like. Examples of an apparatus 200 may include, but is not limited to, the operations processing system 140, the plurality of sensors 110, the one or more user devices 160, and/or the one or more databases 150. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of an operations processing system 140, the plurality of sensors 110, and/or the one or more user devices 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a sensor and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the plurality of assets 102. In some embodiments, the data intake circuitry 212 includes hardware, software, firmware, and/or a combination thereof, that communicates with one or more sensor(s) component(s), and/or the like within the plurality of sensors 110, the plurality of assets 102, the one or more user devices 160, and/or the one or more databases 150 to receive particular data associated with such operations of the plurality of sensors 110, the plurality of assets 102, the one or more user devices 160, and/or the one or more databases 150. Additionally or alternatively, in some embodiments, the data intake circuitry 212 includes hardware, software, firmware, and/or a combination thereof, that retrieves particular data associated with plurality of sensors 110, the plurality of assets 102, the one or more user devices 160, and/or the one or more databases 150 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

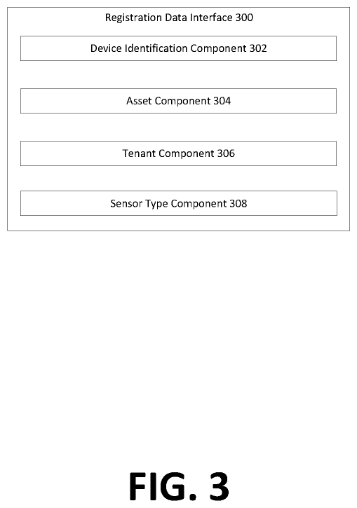

With reference to FIGS. 1-6, in some embodiments, the operations processing system 140 and/or the one or more user devices 160 may be configured to receive registration data. In some embodiments, the registration data may be associated with the plurality of sensors 110. In some embodiments, for example, the registration data may indicate a device identification for each of the plurality of sensors 110 (e.g., a unique identification code for each sensor of the plurality of sensors 110 that uniquely identifies the sensor). As another example, the registration data may indicate an asset associated with each sensor of the plurality of sensors 110 (e.g., the registration data may indicate that a first sensor is associated with a first asset and a second sensor is associated with a second asset). As another example, the registration data may indicate a tenant (e.g., an operator and/or owner of an asset) associated with each sensor of the plurality of sensors 110 (e.g., the registration data may indicate that a first sensor is associated with a first tenant and a second sensor is associated with a second tenant). As another example, the registration data may indicate a sensor type associated with each sensor of the plurality of sensors 110 (e.g., the registration data may indicate that a first sensor is a temperature sensor and that a second sensor is an acceleration sensor).

In some embodiments, the registration data may be received via a registration data interface 300 associated with the operations processing system 140 and/or the one or more user devices 160. In this regard, for example, registration data indicating the device identification for each of the plurality of sensors 110 may be received via a device identification component 302 displayed on the registration data interface 300. As another example, registration data indicating an asset associated with each sensor of the plurality of sensors 110 may be received via an asset component 304 displayed on the registration data interface 300. As another example, registration data indicating a tenant associated with each sensor of the plurality of sensors 110 may be received via a tenant component 306 displayed on the registration data interface 300. As another example, registration data indicating a sensor type associated with each sensor of the plurality of sensors 110 may be received via a sensor type component 308 displayed on the registration data interface 300.

In some embodiments, the operations processing system 140 and/or the one or more user devices 160 may be configured to receive operations data representing operations of the plurality of assets 102. In some embodiments, the operations data may be captured by the plurality of sensors 110. In some embodiments, the operations processing system 140 and/or the one or more user devices 160 may be configured to receive the operations data in real-time. Said differently, the plurality of sensors 110 may be configured to transmit the operations data to the operations processing system 140 and/or the one or more user devices 160 as the plurality of sensors 110 capture the operations data. In some embodiments, the operations data may be associated with a first data size. For example, the operations data may be associated with a first data size between 1 kilobyte and 10 gigabytes (e.g., the first data size may be 1 megabyte). In some embodiments, receiving the operations data representing the operations of the plurality of assets 102 may be associated with a first bandwidth allocation. Said differently, the transmitting of the operations data from the plurality of assets 102 to the operations processing system 140 and/or the one or more user devices 160 may consume a particular amount of bandwidth allocation (e.g., the first bandwidth allocation). In some embodiments, the first bandwidth allocation may be based on first data size. For example, if the first data size is 1 megabyte the first bandwidth allocation may be less than if the first data size is 2 megabytes.

In some embodiments, for example, the operations data may include gas data (e.g., a flow rate of a gas associated with an asset captured by a gas sensor). As another example, the operations data may include temperature data (e.g., a temperature associated with the asset captured by a temperature sensor). As another example, the operations data may include humidity data (e.g., a humidity associated with an asset captured by a humidity sensor). As another example, the operations data may include material composition data (e.g., a composition of a material associated with an asset captured by the material composition sensor). As another example, the operations data may include vibration data (e.g., a vibration associated with an asset captured by a vibration sensor). As another example, the operations data may include acceleration data (e.g., an acceleration associated with an asset captured by the acceleration sensor). As another example, the operations data may include location data (e.g., a location associated with an asset captured by a location sensor).

In some embodiments, the operations processing system 140 and/or the one or more user devices 160 may be configured to apply the operations data to an improvement model to generate improved operations data. In some embodiments, the optimization model may comprise one or more of a statistical model, an algorithmic model, and/or a machine learning model (e.g., using AI and machine learning circuitry 210). For example, the improvement model may implement supervised machine learning and/or unsupervised machine learning. In some embodiments, the operations processing system 140 and/or the one or more user devices 160 may be configured to apply the operations data to generate improved operations in real-time. In this regard, for example, operations data received by the operations processing system 140 and/or the one or more user devices 160 may be continuously applied to the improvement model to generate the improved operations data as the operations data is received by the operations processing system 140 and/or the one or more user devices 160.

In some embodiments, the improved operations data may be generated based at least in part on the registration data and/or the operations data. In this regard, for example, the improved operations data may include a plurality of improved operations data sets. In some embodiments, each improved operations data set of the plurality of improved operations data sets may be associated with one of the plurality of assets 102. Said differently, each improved operations data set may include operations data that is received from one or more of the plurality of sensors 110 that are associated with the asset of the plurality of assets 102 that the improved operations data set is associated with (e.g., based on the registration data for each sensor of the plurality of sensors 110). For example, if the operations data includes operations data captured from a first sensor associated with a first asset and operations data captured by a second sensor associated with a second asset, the improved operations data may include a first improved operations data set comprising the operations data associated with the first asset (e.g., the operations data captured by the first sensor) and a second improved operations data set comprising the operations data associated with the second asset (e.g., the operations data captured by the second sensor).

In some embodiments, each improved operations data set may include asset identification data (e.g., in addition to the received operations data in each improved operations data set). In some embodiments, the asset identification data of each improved operations data may indicate the asset of the plurality of assets 102 associated with the improved operations data set. In some embodiments, the improved operations data may be associated with a second data size (e.g., the plurality of improved operations data sets that make up the improved operations data may be associated with a second data size). In some embodiments, the second data size may be greater than the first data size. In some embodiments, the second data size may be greater than the first data size because each improved operations data set includes asset identification data (e.g., in addition to the received operations data in each improved operations data set).

In some embodiments, the operations processing system 140 and/or the one or more user devices 160 may be configured to initiate performance of one or more improved operations actions based at least in part on the improved operations data. In some embodiments, the one or more improved operations actions may include causing each improved operations data set of the plurality of improved operations data sets to be displayed on an improved operations data set interface of an associated asset of the plurality of assets 102. In this regard, for example, the operations processing system 140 and/or the one or more user devices 160 may be configured to transmit each improved operations data set to an associated asset of the plurality of assets 102.

In some embodiments, transmitting each improved operations data set of the plurality of improved operations data sets (e.g., the plurality of improved operations data sets that make up the improved operations data) to an associated asset of the plurality of assets 102 may be associated with a second bandwidth allocation. Said differently, the transmitting of each improved operations data set of the plurality of improved operations data sets to an associated asset of the plurality of assets 102 may consume a particular amount of bandwidth allocation (e.g., the second bandwidth allocation). In some embodiments, the second bandwidth allocation may be greater than the first bandwidth allocation. In some embodiments, the second bandwidth allocation may be greater than the first bandwidth allocation because the second data size is greater than the first data size (e.g., because each improved operations data set includes asset identification data that identifies which asset each improved operations data set is associated with).

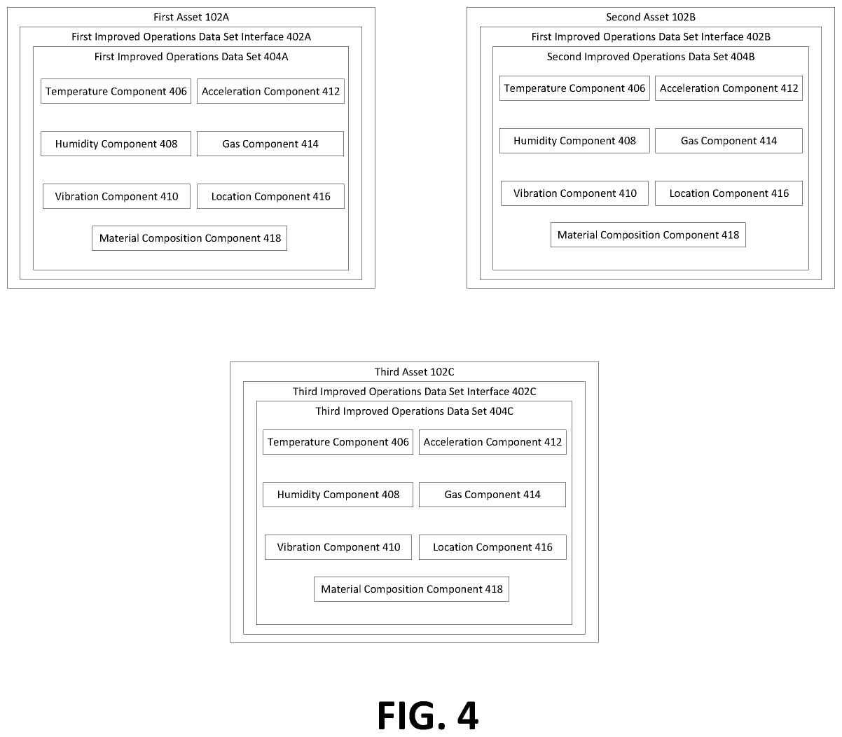

For example, such as illustrated in FIG. 4 in which there are three assets in the plurality of assets 102, the operations processing system 140 and/or the one or more user devices 160 may be configured to cause a first improved operations data set 404A of the plurality of improved operations data sets to be displayed on a first improved operations data set interface 402A associated with a first asset 102A associated with the first improved operations data set 404A. The operations processing system 140 and/or the one or more user devices 160 may be configured to cause a second improved operations data set 404B of the plurality of improved operations data sets to be displayed on a second improved operations data set interface 402B associated with a second asset 102B associated with the second improved operations data set 404B. The operations processing system 140 and/or the one or more user devices 160 may be configured to cause a third improved operations data set 404C of the plurality of improved operations data sets to be displayed on a third improved operations data set interface 402C associated with a third asset 102C associated with the third improved operations data set 404C.

In some embodiments, each improved operations data set interface may include one or more components configured to indicate at least some of the data in an associated improved operations data set. For example, as illustrated in FIG. 4, each improved operations data set interface may include a temperature component 406 to indicate temperature data. As another example, each improved operations data set interface may include a humidity component 408 to indicate humidity data. As another example, each improved operations data set interface may include a vibration component 410 to indicate vibration data. As another example, each improved operations data set interface may include an acceleration component 412 to indicate acceleration data. As another example, each improved operations data set interface may include a gas component 414 to indicate gas data. As another example, each improved operations data set interface may include a location component 416 to indicate location data. As another example, each improved operations data set interface may include a material composition component 418 to indicate material composition data.

In some embodiments, the one or more improved operations actions may include transmitting the improved operations data to the one or more databases 150. In some embodiments, each improved operations data set of the plurality of improved operations data sets is transmitted to a database storage location associated with an associated asset of the plurality of assets 102. In some embodiments, each database storage location may be associated with a database storage location size. In this regard, for example, the database storage location size associated with each improved operations data set may represent an amount of storage space required to store each improved operations data set in the one or more databases 150.

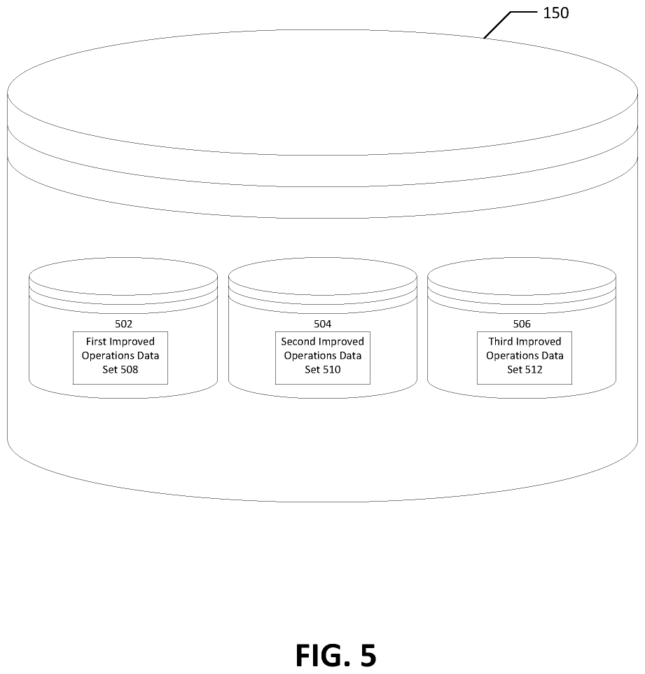

For example, such as illustrated in FIG. 5 in which there are three assets in the plurality of assets 102, the operations processing system 140 and/or the one or more user devices 160 may be configured to transmit a first improved operations data set 508 to a first database storage location 502. In this regard, for example, the first database storage location 502 may be associated with a first asset 102A of the plurality of assets 102. As another example, the operations processing system 140 and/or the one or more user devices 160 may be configured to transmit a second improved operations data set 510 to a second database storage location 504. In this regard, for example, the second database storage location 504 may be associated with a second asset 102B of the plurality of assets 102. As another example, the operations processing system 140 and/or the one or more user devices 160 may be configured to transmit a third improved operations data set 512 to a third database storage location 506. In this regard, for example, the third database storage location 506 may be associated with a third asset 102C of the plurality of assets 102.

In some embodiments, transmitting the improved operations data to the one or more databases 150 may be associated with the second bandwidth allocation. Said differently, the transmitting of improved operations data to the one or more databases 150 may consume a particular amount of bandwidth allocation (e.g., the second bandwidth allocation). In some embodiments, the second bandwidth allocation may be greater than the first bandwidth allocation. In some embodiments, the second bandwidth allocation may be greater than the first bandwidth allocation because the second data size is greater than the first data size (e.g., because each improved operations data set includes asset identification data that identifies which asset each improved operations data set is associated with).

In some embodiments, the one or more improved operations actions may include determining a computing resource consumption for each of the plurality of assets 102 based at least in part on the improved operations data. In some embodiments, the computing resource consumption for each of the plurality of assets 102 may be based on an amount of processing that the operations processing system 140 and/or the one or more user devices 160 performs by applying the operations data to an improvement model to generate the improved operations data for each of the plurality of assets 102. For example, if generating the improved operations data for a first asset of the plurality of assets 102 requires a greater amount of processing than generating the improved operations data for a second asset of the plurality of assets 102, then the computing resources consumption for the first asset may be greater than the computing resource consumption for the second asset. Additionally or alternatively, in some embodiments, the computing resource consumption for each of the plurality of assets 102 may be based on the database storage location size associated with each improved operations data set. For example, if the database storage location size for a first asset of the plurality of assets 102 is greater than the database storage location size for a second asset of the plurality of assets 102, then the computing resources consumption for the first asset may be greater than the computing resource consumption for the second asset. Additionally or alternatively, in some embodiments, the computing resource consumption for each of the plurality of assets 102 may be based on an amount of operations data received from each asset of the plurality of assets 102. For example, if the amount of operations data received from a first asset in the plurality of assets 102 is greater than the amount of operations data received from a second asset in the plurality of assets 102, then the computing resources consumption for the first asset may be greater than the computing resource consumption for the second asset.

In some embodiments, the operations processing system 140 and/or the one or more user devices 160 may be configured to transmit a payment request to each of the plurality of assets 102. In some embodiments, the payment request may be based at least in part on the computing resource consumption associated with each asset of the plurality of assets 102. In this regard, for example, the payment request may indicate a payment amount that a tenant associated with each asset of the plurality of assets 102 may be required to pay based on the computing resource consumption of the asset. In some embodiments, the operations processing system 140 and/or the one or more user devices 160 may be configured to transmit the payment request in real-time (e.g., each time the payment amount changes). Additionally or alternatively, the operations processing system 140 and/or the one or more user devices 160 may be configured to transmit the payment request on a periodic basis (e.g., one per day, once per month, once per year, etc.). Additionally or alternatively, operations processing system 140 and/or the one or more user devices 160 may be configured to transmit the payment request in response to a request for the payment request from an asset of the plurality of assets 102. Additionally or alternatively, the operations processing system 140 and/or the one or more user devices 160 may be configured to transmit the payment request in response to user input (e.g., user input from a user associated with the operations processing system 140 and/or the one or more user devices 160).

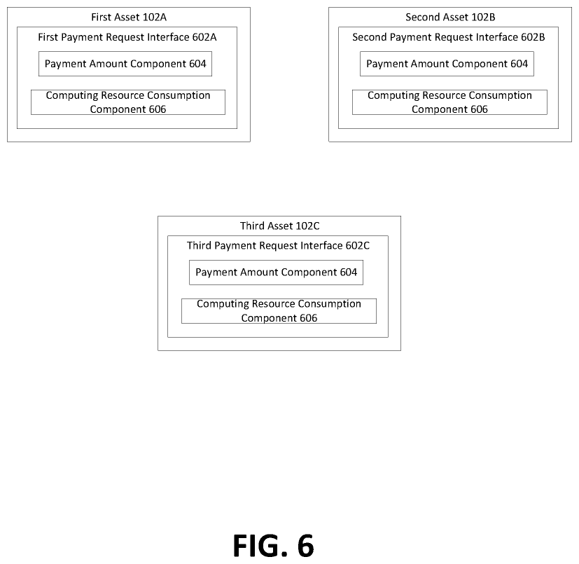

In some embodiments, transmitting the payment request to each of the plurality of assets 102 may include the operations processing system 140 and/or the one or more user devices 160 being configured to cause a payment request interface to be displayed on a user interface associated with each asset of the plurality of assets 102. For example, such as illustrated in FIG. 6 in which there are three assets in the plurality of assets 102, the operations processing system 140 and/or the one or more user devices 160 may be configured to cause a first payment request interface 600A to be displayed on a first asset 102A of the plurality of assets 102, a second payment request interface 600B to be displayed on a second asset 102B of the plurality of assets 102, and a third payment request interface 600C to be displayed on a third asset 102C of the plurality of assets 102. In some embodiments, each payment request interface may include a payment amount component 604 configured to indicate the payment amount that a tenant associated with each asset of the plurality of assets 102 may be required to pay based on the computing resource consumption of the asset. Additionally or alternatively, each payment request interface may include a computing resource consumption component 606 configured to indicate the computing resource consumption of asset associated with the payment request interface.

### Example Methods

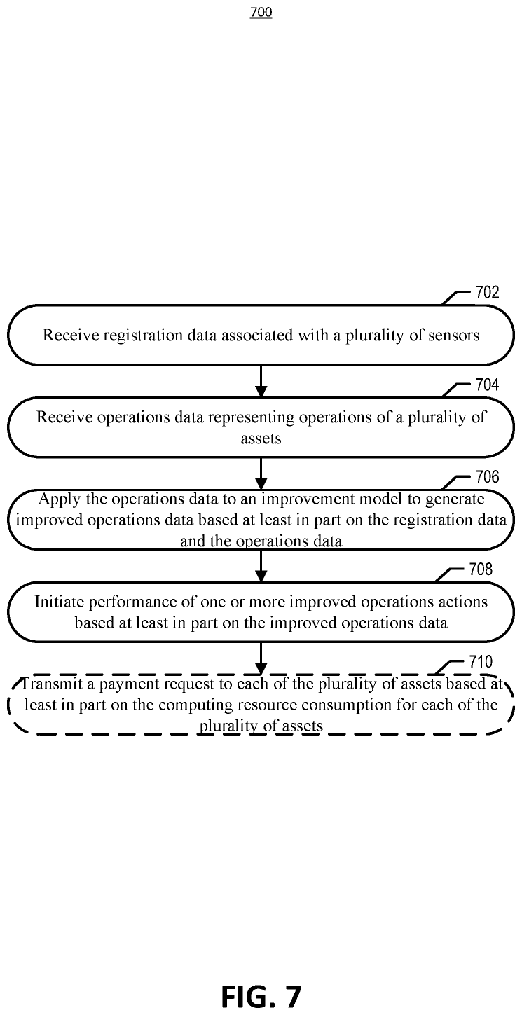

Referring now to FIG. 7, a flowchart providing an example computer-implemented method 700 is illustrated. In this regard, FIG. 7 illustrates operations that may be performed by the operations processing system 140 and/or the one or more user devices 160.

As shown in block 702, the computer-implemented method 700 may include receiving registration data associated with a plurality of sensors. As described above, in some embodiments, the registration data may indicate a device identification for each of the plurality of sensors (e.g., a unique identification code for each sensor of the plurality of sensors that uniquely identifies the sensor). As another example, the registration data may indicate an asset associated with each sensor of the plurality of sensors (e.g., the registration data may indicate that a first sensor is associated with a first asset and a second sensor is associated with a second asset). As another example, the registration data may indicate a tenant (e.g., an operator and/or owner of an asset) associated with each sensor of the plurality of sensors (e.g., the registration data may indicate that a first sensor is associated with a first tenant and a second sensor is associated with a second tenant). As another example, the registration data may indicate a sensor type associated with each sensor of the plurality of sensors (e.g., the registration data may indicate that a first sensor is a temperature sensor and that a second sensor is an acceleration sensor).

As described above, in some embodiments, the registration data may be received via a registration data interface. In this regard, for example, registration data indicating the device identification for each of the plurality of sensors may be received via a device identification component displayed on the registration data interface. As another example, registration data indicating an asset associated with each sensor of the plurality of sensors may be received via an asset component displayed on the registration data interface. As another example, registration data indicating a tenant associated with each sensor of the plurality of sensors may be received via a tenant component displayed on the registration data interface. As another example, registration data indicating a sensor type associated with each sensor of the plurality of sensors may be received via a sensor type component displayed on the registration data interface.

As shown in block 704, the computer-implemented method 700 may include receiving operations data representing operations of a plurality of assets. As described above, in some embodiments, the operations data may be captured by the plurality of sensors. In some embodiments, the operations data may be received in real-time. Said differently, the plurality of sensors may be configured to transmit the operations data as the plurality of sensors capture the operations data. In some embodiments, the operations data may be associated with a first data size. For example, the operations data may be associated with a first data size between 1 kilobyte and 10 gigabytes (e.g., the first data size may be 1 megabyte). In some embodiments, receiving the operations data representing the operations of the plurality of assets may be associated with a first bandwidth allocation. Said differently, the transmitting of the operations data from the plurality of assets may consume a particular amount of bandwidth allocation (e.g., the first bandwidth allocation). In some embodiments, the first bandwidth allocation may be based on first data size. For example, if the first data size is 1 megabyte the first bandwidth allocation may be less than if the first data size is 2 megabytes.

As described above, in some embodiments, the operations data may include gas data (e.g., a flow rate of a gas associated with an asset captured by a gas sensor). As another example, the operations data may include temperature data (e.g., a temperature associated with the asset captured by a temperature sensor). As another example, the operations data may include humidity data (e.g., a humidity associated with an asset captured by a humidity sensor). As another example, the operations data may include material composition data (e.g., a composition of a material associated with an asset captured by the material composition sensor). As another example, the operations data may include vibration data (e.g., a vibration associated with an asset captured by a vibration sensor). As another example, the operations data may include acceleration data (e.g., an acceleration associated with an asset captured by the acceleration sensor). As another example, the operations data may include location data (e.g., a location associated with an asset captured by a location sensor).

As shown in block 706, the computer-implemented method 700 may include applying the operations data to an improvement model to generate improved operations data based at least in part on the registration data and the operations data. As described above, in some embodiments, the improvement model may comprise one or more of a statistical model, an algorithmic model, and/or a machine learning model. In some embodiments, the operations data may be applied to the improvement model in real-time (e.g., the operations data may be continuously applied to the improvement model to generate the improved operations data as the operations data is received).

As described above, in some embodiments, the improved operations data may be generated based at least in part on the registration data and/or the operations data. In this regard, for example, the improved operations data may include a plurality of improved operations data sets. In some embodiments, each improved operations data set of the plurality of improved operations data sets may be associated with one of the plurality of assets. Said differently, each improved operations data set may include operations data that is received from one or more of the plurality of sensors that are associated with the asset of the plurality of assets that the improved operations data set is associated with (e.g., based on the registration data for each sensor of the plurality of sensors). For example, if the operations data includes operations data captured from a first sensor associated with a first asset and operations data captured by a second sensor associated with a second asset, the improved operations data may include a first improved operations data set comprising the operations data associated with the first asset (e.g., the operations data captured by the first sensor) and a second improved operations data set comprising the operations data associated with the second asset (e.g., the operations data captured by the second sensor).

As described above, in some embodiments, each improved operations data set may include asset identification data (e.g., in addition to the received operations data in each improved operations data set). In some embodiments, the asset identification data of each improved operations data may indicate the asset of the plurality of assets associated with the improved operations data set. In some embodiments, the improved operations data may be associated with a second data size (e.g., the plurality of improved operations data sets that make up the improved operations data may be associated with a second data size). In some embodiments, the second data size may be greater than the first data size. In some embodiments, the second data size may be greater than the first data size because each improved operations data set includes asset identification data (e.g., in addition to the received operations data in each improved operations data set).

As shown in block 708, the computer-implemented method 700 may include initiating performance of one or more improved operations actions based at least in part on the improved operations data. As described above, in some embodiments, the one or more improved operations actions may include causing each improved operations data set of the plurality of improved operations data sets to be displayed on an improved operations data set interface of an associated asset of the plurality of assets. In this regard, for example, each improved operations data set may be transmitted to an associated asset of the plurality of assets.

As described above, in some embodiments, transmitting each improved operations data set of the plurality of improved operations data sets (e.g., the plurality of improved operations data sets that make up the improved operations data) to an associated asset of the plurality of assets may be associated with a second bandwidth allocation. In some embodiments, the second bandwidth allocation may be greater than the first bandwidth allocation. In some embodiments, the second bandwidth allocation may be greater than the first bandwidth allocation because the second data size is greater than the first data size (e.g., because each improved operations data set includes asset identification data that identifies which asset each improved operations data set is associated with).

As described above, in some embodiments, the one or more improved operations actions may include transmitting the improved operations data to the one or more database. As described above, in some embodiments, each improved operations data set of the plurality of improved operations data sets is transmitted to a database storage location associated with an associated asset of the plurality of assets. In some embodiments, each database storage location may be associated with a database storage location size. In this regard, for example, the database storage location size associated with each improved operations data set may represent an amount of storage space required to store each improved operations data set in the one or more databases. As described above, in some embodiments, transmitting the improved operations data to the one or more databases may be associated with the second bandwidth allocation. In some embodiments, the second bandwidth allocation may be greater than the first bandwidth allocation. In some embodiments, the second bandwidth allocation may be greater than the first bandwidth allocation because the second data size is greater than the first data size (e.g., because each improved operations data set includes asset identification data that identifies which asset each improved operations data set is associated with).

As described above, in some embodiments, the one or more improved operations actions may include determining a computing resource consumption for each of the plurality of assets based at least in part on the improved operations data. In some embodiments, the computing resource consumption for each of the plurality of assets may be based on an amount of processing is performed by applying the operations data to an improvement model to generate the improved operations data for each of the plurality of assets. For example, if generating the improved operations data for a first asset of the plurality of assets requires a greater amount of processing than generating the improved operations data for a second asset of the plurality of assets, then the computing resources consumption for the first asset may be greater than the computing resource consumption for the second asset. Additionally or alternatively, in some embodiments, the computing resource consumption for each of the plurality of assets may be based on the database storage location size associated with each improved operations data set. For example, if the database storage location size for a first asset of the plurality of assets is greater than the database storage location size for a second asset of the plurality of assets, then the computing resources consumption for the first asset may be greater than the computing resource consumption for the second asset. Additionally or alternatively, in some embodiments, the computing resource consumption for each of the plurality of assets may be based on an amount of operations data received from each asset of the plurality of assets. For example, if the amount of operations data received from a first asset in the plurality of assets is greater than the amount of operations data received from a second asset in the plurality of assets, then the computing resources consumption for the first asset may be greater than the computing resource consumption for the second asset.

As shown in block 710, the computer-implemented method 700 may optionally include transmitting a payment request to each of the plurality of assets based at least in part on the computing resource consumption for each of the plurality of assets. As described above, in some embodiments, the payment request may be based at least in part on the computing resource consumption associated with each asset of the plurality of assets. In this regard, for example, the payment request may indicate a payment amount that a tenant associated with each asset of the plurality of assets may be required to pay based on the computing resource consumption of the asset. In some embodiments, the payment request may be transmitted in real-time (e.g., each time the payment amount changes). Additionally or alternatively, the payment request may be transmitted on a periodic basis (e.g., one per day, once per month, once per year, etc.). Additionally or alternatively, the payment request may be transmitted in response to a request for the payment request from an asset of the plurality of assets. Additionally or alternatively, the payment request may be transmitted in response to user input.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed:

1. A computer-implemented method comprising:
receiving registration data associated with a plurality of sensors;
receiving operations data representing operations of a plurality of assets, wherein the operations data is captured by the plurality of sensors;
applying the operations data to an improvement model to generate improved operations data based at least in part on the registration data and the operations data, wherein the improved operations data comprises a plurality of improved operations data sets, wherein each improved operations data set of the plurality of improved operations data sets is associated with one of the plurality of assets; and
initiating performance of one or more improved operations actions based at least in part on the improved operations data.

2. The computer-implemented method of claim 1, wherein applying the operations data to the improvement model to generate improved operations data occurs in real-time.

3. The computer-implemented method of claim 1, wherein the one or more improved operations actions comprises:
causing each improved operations data set of the plurality of improved operations data sets to automatically be displayed on an improved operations data set interface of an associated asset of the plurality of assets.

4. The computer-implemented method of claim 1, wherein the one or more improved operations actions comprises:
transmitting the improved operations data to a database, wherein each improved operations data set of the plurality of improved operations data sets is transmitted to a database storage location associated with an associated asset of the plurality of assets.

5. The computer-implemented method of claim 4, wherein receiving operations data representing operations of a plurality of assets is associated with a first bandwidth allocation and transmitting the improved operations data to a database is associated with a second bandwidth allocation.

6. The computer-implemented method of claim 5, wherein the second bandwidth allocation is greater than the first bandwidth allocation.

7. The computer-implemented method of claim 1, wherein the one or more improved operations actions comprises:
determining a computing resource consumption for each of the plurality of assets based at least in part on the improved operations data.

8. The computer-implemented method of claim 7, further comprising:
transmitting a payment request to each of the plurality of assets based at least in part on the computing resource consumption for each of the plurality of assets.

9. The computer-implemented method of claim 1, wherein the plurality of assets comprise at least one building, at least one plant, or at least one vehicle.

10. The computer-implemented method of claim 1, wherein the operations data is associated with a first data size and the improved operations data is associated with a second data size, wherein the second data size is greater than the first data size.

11. An apparatus comprising at least one processor and at least one memory coupled to the at least one processor, wherein the at least one processor is configured to:
receive registration data associated with a plurality of sensors;
receive operations data representing operations of a plurality of assets, wherein the operations data is captured by the plurality of sensors;
apply the operations data to an improvement model to generate improved operations data based at least in part on the registration data and the operations data, wherein the improved operations data comprises a plurality of improved operations data sets, wherein each improved operations data set of the plurality of improved operations data sets is associated with one of the plurality of assets; and
initiate performance of one or more improved operations actions based at least in part on the improved operations data.

12. The apparatus of claim 11, wherein applying the operations data to the improvement model to generate improved operations data occurs in real-time.

13. The apparatus of claim 11, wherein the at least one processor is configured to:
cause each improved operations data set of the plurality of improved operations data sets to automatically be displayed on an improved operations data set interface of an associated asset of the plurality of assets.

14. The apparatus of claim 11, wherein the at least one processor is configured to:
transmit the improved operations data to a database, wherein each improved operations data set of the plurality of improved operations data sets is transmitted to a database storage location associated with an associated asset of the plurality of assets.

15. The apparatus of claim 14, wherein receiving operations data representing operations of a plurality of assets is associated with a first bandwidth allocation and transmitting the improved operations data to a database is associated with a second bandwidth allocation.

16. The apparatus of claim 15, wherein the second bandwidth allocation is greater than the first bandwidth allocation.

17. The apparatus of claim 11, wherein the at least one processor is configured to:
determine a computing resource consumption for each of the plurality of assets based at least in part on the improved operations data.

18. The apparatus of claim 17, wherein the at least one processor is configured to:
transmit a payment request to each of the plurality of assets based at least in part on the computing resource consumption for each of the plurality of assets.

19. The apparatus of claim 11, wherein the operations data is associated with a first data size and the improved operations data is associated with a second data size, wherein the second data size is greater than the first data size.

20. A non-transitory computer-readable storage medium comprising computer program code for execution by one or more processors of a device, the computer program code configured to, when executed by the one or more processors, cause the device to:
receive registration data associated with a plurality of sensors;
receive operations data representing operations of a plurality of assets, wherein the operations data is captured by the plurality of sensors;
apply the operations data to an improvement model to generate improved operations data based at least in part on the registration data and the operations data, wherein the improved operations data comprises a plurality of improved operations data sets, wherein each improved operations data set of the plurality of improved operations data sets is associated with one of the plurality of assets; and
initiate performance of one or more improved operations actions based at least in part on the improved operations data.
